(19) United States
(12) Patent Application Publication
(10) Pub. No.: US 2008/0043417 A1
(43) Pub. Date: Feb. 21, 2008

(54) PERIPHERAL DEVICE INTEGRATED UBIQUITOUS MULTIFUNCTION PERSONAL COMPUTER

(75) Inventors: Byong-rok Lee, Seo-gu (KR); Yong-hwan Cho, Seocho-gu (KR)

Correspondence Address: OBLON, SPIVAK, MCCLELLAND MAIER & NEUSTADT, P.C., 1940 DUKE STREET, ALEXANDRIA, VA, 22314, US

(73) Assignee: UBI-COM Technology Co., Ltd., Yuseong-gu (KR)

(21) Appl. No.: 11/565,863

(22) Filed: Dec. 1, 2006

(30) Foreign Application Priority Data
Aug. 2, 2006 (KR) 10-2006-0073095

(51) Int. Cl. G06F 1/16

(52) U.S. Cl. 361/683

(57) ABSTRACT

Disclosed is a peripheral device integrated ubiquitous multifunction PC in which an internet phone device and a PLC modem are integrated. The multifunction PC integrated with a monitor includes a main body including a case provided with basic components and an internet telephone apparatus, and an LCD panel at the front side, and a stand at the lower side of the main body to support the main body. The main body includes a power supply of the case and connected to a power line, a modem provided in the case and including a PLC modem connected to the power supply to modulate/demodulate a signal transmitted through the power line, a telephone receiver provided at a side of the case, and a web-camera provided at the front upper side of the case. The stand includes dial buttons and a key telephone that are provided in the front side thereof.

### BACKGROUND OF THE INVENTION

1. Field of the Invention

The present invention relates to a computer, in which a peripheral device is integrally installed in a main body, and more particularly, to a peripheral device integrated ubiquitous multifunction personal computer in which peripheral devices such as an internet telephone apparatus, a power line communication modem, and the like are integrally installed.

2. Description of the Related Art

Generally, a personal computer (PC) includes a main body that has a microprocessor and processes an inputted command, a keyboard and a mouse connected to input ports to input various commands to the main body, a speaker connected to an output port of the main body to output sound, and a monitor to output a visual image.

Generally, the PC is implemented by a laptop computer or a desktop computer, and the desktop computer is mostly installed and used at a specific space in an office or home.

In the desktop computer, since the main body, the keyboard, the mouse, the speaker, and the monitor are separated from each other, a large space is needed to install the desktop computer.

Thus, recently, the main body of the desktop computer has a trend to be thin, and a thin liquid crystal display is being popularized as the monitor.

However, although the respective devices are thin, since the main body, the monitor, the keyboard, and the like are separated from each other, it is complicated to assemble them, and connecting cables occupy a large space, so a working space is not sufficiently secured.

In order to solve the problem, a computer in which the LCD monitor is integrated with the main body is proposed.

FIG. 4 is a perspective view illustrating a conventional liquid crystal display monitor integrating computer.

As illustrated in the drawing, the LCD monitor integrated computer includes an LCD monitor 100, a main body 200 detachable attached to the rear side of the LCD monitor 100, and an interface installed in the main body to connect a keyboard, a mouse, and various devices to the main body.

Moreover, the main body 200 includes internal components such as a small capacity power supply, a main board, a printed circuit board (PCB), and a LAN card.

Moreover, the main body 200 supplies electric power to, supports graphic to, and carries out a serial communication with the LCD monitor, through a predetermined interface connector.

The main body 200 of the conventional computer is a small size and is able to be attached to and detached from another type LCD monitor. When a user wishes upgrade of the main body 200, the LCD monitor having a lifespan longer than that of the main body is not replaced and simply the main body is replaced so that the user can upgrade the whole system of the conventional computer.

Recently, internet telephony (voice over internet protocol: VoIP) enabling phone calls using an internet phone technology is popularized.

The internet telephony using the VoIP technology is a technology that enables a user to make a circuit switching vocal conversation using a public internet packet switching data network, is generally serviced by PC-to-PC connection, PC-to-phone connection, and phone-to-phone connection, and is roughly classified into two types.

Firstly, there is a web-phone type that the internet telephony is carried out by a computer. This is a communication method that a user accesses an internet service provider (ISP) through a point-to-point protocol as software for a modem and the internet connection and an IP address is assigned to prepare to drive TCP/IP, the user accesses a host of the other party for the vocal communication, the user starts an internet program for the connection to a telephone receiver, and takes a phone conversation with the telephone receiver when a vocal conversation path is connected by the telephone receiver's response.

In the above-mentioned internet telephony, the calling and reception are possible only when the user's computer is powered on and is connected to the internet. Moreover, since a microphone is connected to the user's computer for the telephone communication, it is inconvenient to use and it is difficult to improve a user's convenience.

Secondly, there is an IP phone that can be used like a traditional telephone every time when an internet line is connected to the internet telephone instead to drive a computer, an ID of a subscriber is inputted, and gatekeeper information is set once, and the telephone communication is enabled without turning on the computer.

However, since the IP telephony is used to be directly connected to the modem without turning on a computer, there is a burden at the expense of buying a VoIP demand telephone in which a set-top box is integrally formed with a telephone.

Moreover, if a conventional modem is used, a power line cable and a modem cable must be separately connected.

### SUMMARY OF THE INVENTION

Therefore, the present invention has been made in view of the above and/or other problems, and it is an aspect of the present invention to provide a peripheral device integrated ubiquitous multifunction personal computer in which an internet telephone (VoIP telephone), a monitor, and a main body of a computer are integrally formed with each other to effectively use an installation space and there is no necessity of the internet telephone so that a purchasing fee can be saved.

It is another aspect of the present invention to provide a peripheral device integrated ubiquitous multifunction personal computer in which a power line modem is built in a main body of a computer so as to use a power cable of the computer as a power line communication cable so that there is no need of connecting a communication line, and thus, configuration of a network is simple and space can be effectively used.

In accordance with the present invention, the above and other objects can be accomplished by the provision of a peripheral device integrated ubiquitous multifunction personal computer in which a monitor is integrally formed, comprising: a main body including a case in which basic components and an internet telephone apparatus are installed, and a liquid crystal display panel provided in the front side of the case; a stand provided at the lower side of the main body to support the main body; the main body comprising: a power supply provided in the case and connected to a power line; a communication modem provided in the case and including a power line communication modem connected to the power supply to modulate and demodulate a communication signal transmitted through the power line; a telephone receiver provided at a side of the case; and a web-camera provided at the front upper side of the case; the stand including dial buttons and a key telephone that are provided in the front side thereof.

The internet telephone apparatus is connected to the communication modem and is operated without operation of the computer.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a perspective view illustrating a front side of a peripheral device integrated ubiquitous multifunction personal computer according to the present invention;

FIG. 2 is a block diagram illustrating a communication modem installed in the peripheral device integrated ubiquitous multifunction personal computer according to the present invention;

FIG. 3 is a block diagram schematically illustrating an internet telephone apparatus according to the present invention; and

FIG. 4 is an exploded perspective view illustrating an example of a conventional liquid crystal display monitor integrated computer.

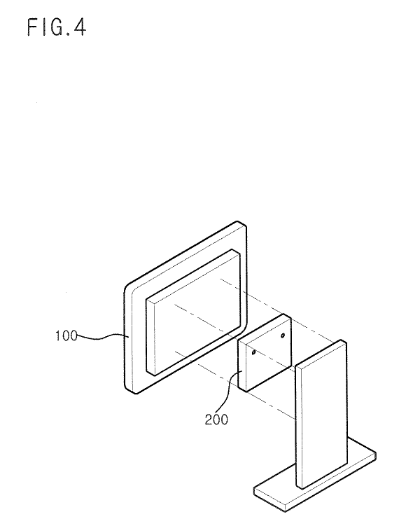

### DESCRIPTION OF THE PREFERRED EMBODIMENTS

Hereinafter, a peripheral device integrated ubiquitous multifunction personal computer according to embodiments of the present invention will be described in detail with reference to the accompanying drawings. The embodiments of the present invention will be described in detail with reference to accompanying drawings such that those skilled in the art may fully understand the concept of the present invention.

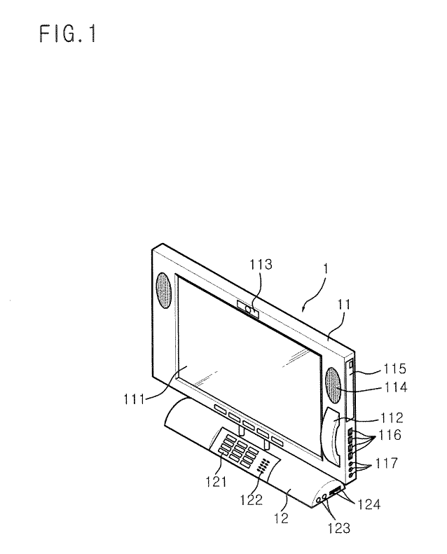

FIG. 1 is a perspective view illustrating a front side of a peripheral device integrated ubiquitous multifunction personal computer according to the present invention.

Referring to the drawing, the peripheral device integrated ubiquitous multifunction personal computer according to an embodiment of the present invention includes a main body 1 in which a liquid crystal display (LCD) panel 111 is provided in front of a case 11, and a stand 12 is provided at the lower side of the main body 1 to support the main body 1.

The main body 1, although not depicted in the drawings, includes basic components, an internet telephone apparatus, a power line communication (PLC) modem to modulate/demodulate communication signals to be transmitted to and to be received from a power line that are installed in the case 11.

Moreover, an internet telephone receiver 112 is provided at a side of the case, and a web-camera 113 is provided in the upper side of the case 11.

Moreover, speakers 114 are provided in the front side of the main body 1, a Read-and-Write CD-ROM drive 115 is provided at a side of the case 11, a plurality of USB ports 116 is provided at a side of the case, and a plurality of audio input/output ports 117 is provided at a side of the case 11.

The stand 12 includes dial buttons 121 and a microphone 122 provided in the front side thereof, and a plurality of input and output ports, for example, plural PS/2 ports 123 and plural USB ports 124 provided at a side thereof as a keyboard connecting port and a mouse connecting port.

The LCD panel 111 is an LCD panel employed in a general LCD monitor, its size may vary but a 19-inche LCD panel is employed in this embodiment of the present invention. Components, which supply an electric power to the LCD monitor and carry out a graphic support and a serial communication, are installed in the main body 1.

The main body of the peripheral device integrated ubiquitous multifunction personal computer according to the embodiment of the present invention includes a 60 Giga-byte hard disk HDD, a 3.0 Generation CPU, and a 1 Giga-byte memory. However, the main body 1 is not limited to this specification, but various modifications are possible.

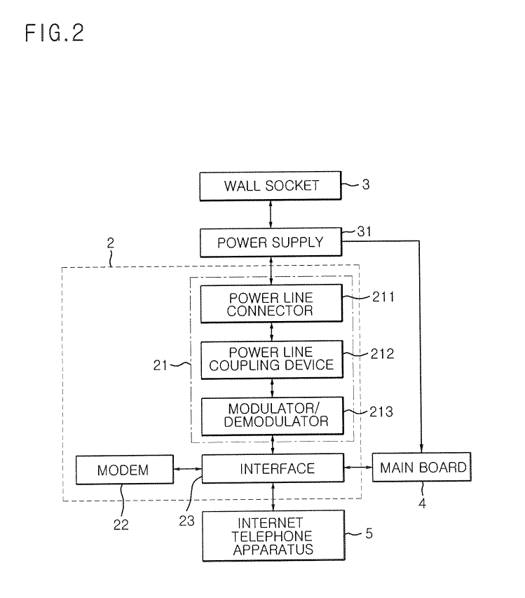

FIG. 2 is a block diagram illustrating the communication modem 2 installed in the peripheral device integrated ubiquitous multifunction personal computer according to the present invention. The communication modem 2 includes a power line modem, namely, a PLC modem 21 and a conventional modem 22.

The PLC modem 21 includes a power line connector 211, a power line coupling device 212, and a modulator/demodulator 213. The PLC model 21 shares an interface 23 with the conventional modem 22 and connects with the internet telephone apparatus 5 through the interface 23 and with a main board 4 through a signal line.

The power line connector 211 of the PLC modem 21 has an end to be connected to a power supply 31, and the power supply 31 connects with the power line through which a communication signal and a power signal are transferred by which an end of the power supply 31 is plugged into a wall socket 3.

The power line coupling device 212 extracts an input communication signal coupled with the power supply 31, and includes, although not depicted in the drawing in detail, a coil and a capacitor to extract the input communication signal coupled with the power supply 31.

The modulator/demodulator 213 demodulates a frequency of the communication signal coupled by the power line coupling device 212 into an original signal and outputs the same to the interface 23, and modulates a frequency of the communication signal that is outputted from the internet telephone apparatus 5 and the main board 4 and is inputted to the interface 23, into a signal to be coupled with the power supply 31. The modulator/demodulator 213 may further include an amplifier to the demodulated signal by a predetermined level.

Between the conventional modem 22 and the PLC modem 21 and between the internet telephone apparatus and the main board, the interface 23 converts the communication signal outputted from the conventional modem 22 or the demodulated signal outputted from the modulator/demodulator 213 of the PLC modem 21 into a signal to be accepted by the main board or the internet telephone apparatus 5 to transmit the same, and selectively outputs the signal outputted from the internet telephone apparatus 5 or the main board 4 to the conventional modem 22 or the PLC modem 21. The interface 23, although not depicted in the drawing, may further include an analog/digital (A/D) converter and a digital/analog (D/A) converter.

According to the configuration, when the external alternating current power and the communication signal are inputted to the power supply 31 through the power line plugged in the wall socket 3, the power line coupling device 212 connected to the power supply 31 extracts the communication signal from the power supply 31 and delivers the extracted communication signal to the modulator/demodulator 213.

By doing so, the modulator/demodulator 213 receives the communication signal outputted from the power line coupling device 212 to demodulate the communication signal into the original signal, to amplify the demodulated communication signal at a predetermined level, and outputs the amplified communication signal to the interface 23.

Then, the interface 23 converts the communication signal into a signal to be received by the main board 4 or the internet telephone apparatus 5 and outputs the converted communication signal to the main board 4 or the internet telephone apparatus 5 through the signal line.

On the other hand, the communication signal outputted from the internet telephone apparatus 5 or the main board 4 is transmitted to the modulator/demodulator 213 via the interface 23, the modulator/demodulator 213 modulates a corresponding signal into a signal with a frequency to be coupled with the power line and delivers the modulated signal to the power supply 31 through the power line connector 211 via the power line coupling device 212.

The communication signal transmitted by the above-mentioned way is delivered to the exterior through the power line.

In a system in which the communication is not transmitted through the power line, the AC power is inputted to the system through the power line, and the communication signal is transmitted by the conventional modem 22 connected to an internet repeater.

As such, according to the present invention, the PLC modem is installed in the computer so that the computer can receive the AC power through the power line communication system and can transmit and receive a communication signal without a cable such as a LAN cable.

Otherwise, in a case of the power line communication system not used, the internet telephony conversation is enabled by the conventional modem 22 without turning on the computer.

In this case, although not depicted in the drawing, in addition to the internet telephone apparatus 5, when a plurality of key telephone sets, in which Bluetooth modules are respectively installed, are installed in the home in the form of a home network, voice and data of respective clients are transmitted via a wireless line using the Bluetooth modules regardless of a place and a communication line to enable interactive communication so that the plural key telephones serve as a local key telephone system.

In other words, an IP router is provided in the main internet telephone apparatus 5 such that the main internet telephone apparatus 5 is assigned by a fixed IP address and other key telephones are assigned by dynamic IP addresses that are tabled to assign local phone numbers to the key telephones so as to enable the communication regardless of a place and a communicating line.

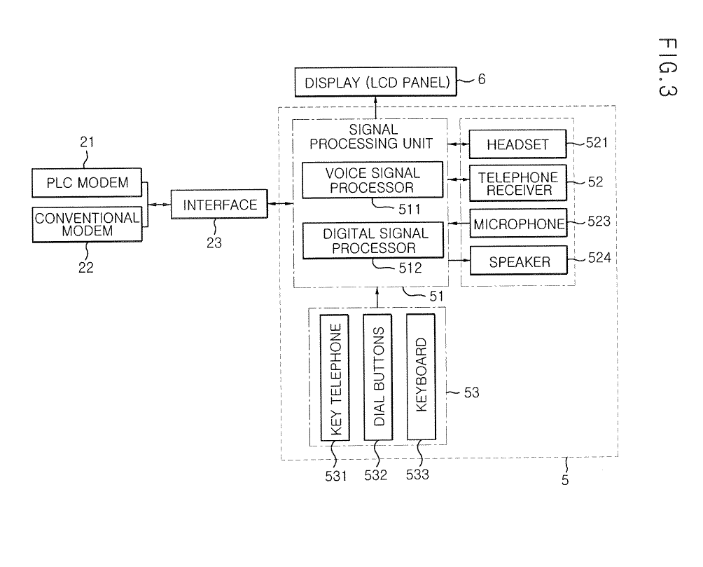

FIG. 3 is a block diagram schematically illustrating the internet telephone apparatus according to the present invention. The internet telephone apparatus includes a signal processing unit having a digital signal processor 512 and a vocal signal processor 511, a telephone transmitting and receiving unit 52 to transmit and receive a vocal signal to and from the vocal signal processor 511, and an input unit 53.

The telephone transmitting and receiving unit 52 includes a headset 521 to transmit and receive voice to and from the voice signal processor 511, a telephone receiver 522, and a microphone 523, and may further include a speaker 524 to receive voice from the voice signal processor 511.

The input unit 53 is a device to input a telephone number and may include a function key such as a key telephone 531, dial buttons 532, and a keyboard 533.

In the above configuration of the internet telephony, the conventional modem 22 and the PLC modem 21 modulate the communication signal and transmit the modulated communication signal to the digital signal processor 512.

Then, the digital signal processor 512 analyzes and processes the signal, determines whether the signal indicates its own IP address, inquires data, and displays the data on a display 6 such as an LCD panel.

When the user attempts a telephone conversation using the headset 521 or the telephone receiver 522 of the telephone transmitting and receiving unit 52, the digital signal processor 512 transmits the demodulated signal to the voice signal processor 511, and the voice signal processor 511 converts the demodulated signal into an electric analog signal to transmit the same to the telephone transmitting and receiving unit 52.

The transmitted analog signal is amplified by the speaker 524, the headset 521, or the telephone receiver 522 and is transmitted to the user.

On the other hand, when the user speaks with the telephone receiver 522, the headset 521, or the microphone 523, the user's voice is converted into an electric analog signal and the converted analog signal is transmitted to the voice signal processor 511.

Then, the voice signal processor 511 transmits the signal to the digital signal processor 512, the digital signal processor 512 digitalizes the signal through the filtering and distortion correction of the signal by performing several operations and the digitalized signal is transmitted to the conventional modem 22 or the PLC modem 21.

The signal is modulated and outputted to the exterior through the communication line by the conventional modem 22 or the PLC modem 21.

As described above, according to the present invention, the internet telephone (VoIP), the monitor, and the main body of the computer are integrated so that an installation space can be effectively used and there is no need to buy an internet telephone so that costs can be reduced.

Moreover, since the power line communication modem is built in the main body of the computer to utilize the power cable of the computer as a power line communication line so that a separate communication line is not required, the network is simply constructed, and a space is effectively used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A peripheral device integrated ubiquitous multifunction personal computer in which a monitor is integrally formed, comprising:
a main body including a case in which basic components and an internet telephone apparatus are installed, and a liquid crystal display panel provided in the front side of the case;
a stand provided at the lower side of the main body to support the main body;
the main body comprising:
a power supply provided in the case and connected to a power line;
a communication modem provided in the case and including a power line communication modem connected to the power supply to modulate and demodulate a communication signal transmitted through the power line;
a telephone receiver provided at a side of the case; and
a web-camera provided at the front upper side of the case;
the stand including dial buttons and a key telephone that are provided in the front side thereof.

2. The peripheral device integrated ubiquitous multifunction personal computer according to claim 1, wherein the main body further comprises:
a speaker provided at the front side of the case;
a CD-ROM drive inserted into a side of the case;
a plurality of USB ports provided at a side of the case; and
a plurality of audio output ports provided at a side of the case.

3. The peripheral device integrated ubiquitous multifunction personal computer according to claim 2, wherein the stand further comprises a plurality of input and output ports provided at a side of the stand.

4. The peripheral device integrated ubiquitous multifunction personal computer according to claim 1, wherein the internet telephone apparatus is connected to the communication modem and is operated without operation of the computer.
